(19) United States
(12) Patent Application Publication
(10) Pub. No.: US 2008/0063811 A1
(43) Pub. Date: Mar. 13, 2008

(54) METHOD OF ADJUSTING SURFACE CHARACTERISTIC OF SUBSTRATE

(75) Inventors: Chau-Hui Wang, Kaohsiung City (TW); Tsung-Hui Cheng, Hsinchu City (TW); Hsun-Yu Li, Taichung City (TW); Hsin-Ching Kao, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/623,091

(22) Filed: Jan. 15, 2007

(30) Foreign Application Priority Data
Sep. 13, 2006 (TW) 95133848

(51) Int. Cl. H05H 1/24

(52) U.S. Cl. 427/569; 427/578; 427/579

(57) ABSTRACT

A method of adjusting a surface characteristic of a substrate is provided, which includes the following steps. A substrate is provided. An atmosphere pressure plasma process is performed on the surface of the substrate to form a film layer on the surface of the substrate, so as to adjust the surface energy of the substrate, wherein a process gas of the atmosphere pressure plasma process includes a surface modifying precursor, a carrier gas and a plasma ignition gas. In particular, the surface modifying precursor is selected from fluorosilane, polysiloxane and a combination thereof, and the ratio of fluorosilane to polysiloxane is between 0 and 1.

### CROSS-REFERENCE TO RELATED APPLICATION

This application claims the priority benefit of Taiwan application serial no. 95133848, filed on Sep. 13, 2006. All disclosure of the Taiwan application is incorporated herein by reference.

### BACKGROUND OF THE INVENTION

1. Field of Invention

The present invention relates to a method of adjusting a surface characteristic of a substrate, and more particularly, to a method of adjusting a surface characteristic of a substrate by an atmosphere pressure plasma process.

2. Description of Related Art

Recently, as the thinning and miniaturizing requirements of the household goods required by people in daily life, many industries have devoted their effects in the research of the nanometer technology. Particularly, the application of self-cleaning product significantly reduces the maintaining cost of products and improves the quality of products. Therefore, the development of the self-cleaning paints has been focused. The self-cleaning paints may be applied to glass of the building, kitchen, and bathroom equipments, solar battery, satellite antenna, automobile windscreen, ship and airplane housings, etc. Most of the self-cleaning paints utilizes the lotus effect that the rough surface is used to restrict the air molecules to generate air cushions, and due to the surface characteristic of the paint with the low surface energy, the contact angle of the water drop of the coating layer is made to be larger than 100 degrees, thus, the adherence of the water drop and the oil drop is reduced.

In the current technologies of self-cleaning paints, one of the technologies is to use a wet process, that is, the wet process is used to perform surface modifying on the surface of the substrate. In the method, firstly, the surface of the substrate is cleaned and activated. Next, the immersion process, the polymerizing reaction, the drying process, and cross-linking reaction are performed. Therefore, the whole process uses a large quantity of solvent, and consumes quite a long time.

Another method is to use a vacuum evaporation process to perform surface modifying on the surface of the substrate. However, the method requires using the vacuum equipment, and requires the time period waiting for the vacuum pumping during operation. Therefore, it has a high cost, and consumes a long processing time.

In U.S. Pat. No. 5,230,929, U.S. Pat. No. 5,334,454, U.S. Pat. No. 5,733,610, U.S. Pat. No. 5,718,967, U.S. Pat. No. 5,298,587, U.S. Pat. No. 5,320,875 and U.S. Pat. No. 6,667,553, it is disclosed that, the ordinary pressure or the low pressure is used for the deposition step, so as to change the surface characteristic of the substrate. However, the equipment and the material used in the above method are not the same as that of the present invention.

### SUMMARY OF THE INVENTION

The present invention is directed to a method of adjusting a surface characteristic of a substrate, using an atmosphere pressure plasma process to change the surface characteristic of the substrate surface, which has the advantages of low cost and short processing time, compared with the conventional method.

In order to achieve the above or other objects, the present invention provides a method of adjusting a surface characteristic of a substrate. The method comprises the following steps: a substrate is provided, and then, an atmosphere pressure plasma process is performed on the surface of the substrate to form a film layer on the surface of the substrate to adjust the surface energy of the substrate. A process gas of the atmosphere pressure plasma process comprises a surface modifying precursor, a carrier gas and a plasma ignition gas. Particularly, the surface modifying precursor is selected from fluorosilane, polysiloxane and a combination thereof, and the ratio of fluorosilane to polysiloxane is between 0 and 1.

In the present invention, the atmosphere pressure plasma process is adopted to adjust the surface characteristic of the substrate, so no vacuum equipments are required, thus, the cost is low and the process time is short. Furthermore, the surface modifying precursor used in the present invention provides the surface of the substrate with hydrophobic, lipophobic, or hydrophobic and lipophobic characteristics.

In order to make the aforementioned and other objects, features and advantages of the present invention comprehensible, preferred embodiments accompanied with figures are described in detail below.

### BRIEF DESCRIPTION OF THE DRAWINGS

FIG. 1 is a flow chart of a method of adjusting a surface characteristic of a substrate according to an embodiment of the present invention.

FIG. 2 is a schematic view of an atmosphere pressure plasma equipment according to an embodiment of the present invention.

### DESCRIPTION OF EMBODIMENTS

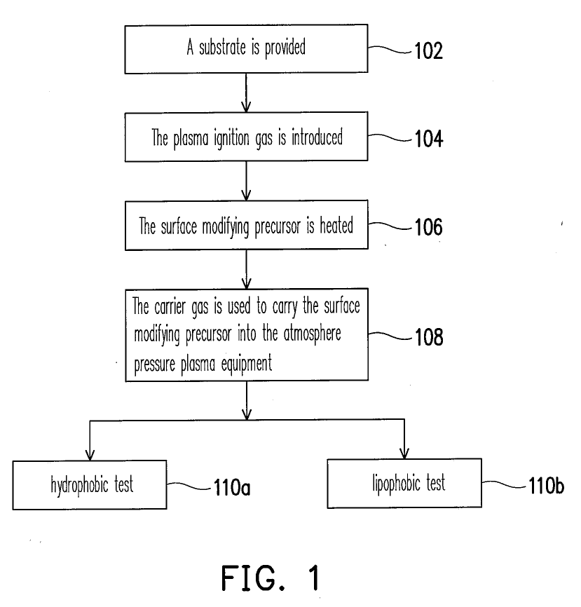

FIG. 1 is a flow chart of a method of adjusting a surface characteristic of a substrate according to an embodiment of the present invention. Referring to FIG. 1, a substrate is provided (Step 102). The material of the substrate is, for example, an organic material or an inorganic material. In an embodiment, the organic material is, for example, cotton, polyethylene terephthalate (PET), polycarbonate (PC) or another suitable organic material. In another embodiment, the inorganic material is, for example, glass, metal, ceramic or another inorganic material.

Next, a plasma ignition gas is introduced (Step 104). That is, a plasma ignition gas is introduced into an atmosphere plasma equipment to ignite the plasma. In a preferred embodiment, at this time, the plasma is used to clean the surface of the substrate, such that the surface of the substrate is made to generate active free radicals. In one embodiment, the plasma ignition gas includes air, nitrogen gas, argon gas, oxygen gas, helium gas or a mixture of the above two or more gases. The plasma ignition gas is mainly used to ignite the plasma. After that, the resulted plasma gas bombards the surface of the substrate, so as to clean the surface of the substrate, and meanwhile make the surface of the substrate generate active free radicals.

Next, the surface modifying precursor is heated (Step 106). The surface modifying precursor is evaporated to gas after being heated. The temperature for heating the surface modifying precursor is between 150° C. and 200° C. In another embodiment, if the surface modifying precursor has a low boiling point, the surface modifying precursor does not need to be heated. Furthermore, the surface modifying precursor may be solid, liquid, gas or powder. Particularly, the surface modifying precursor is selected from fluorosilane, polysiloxane and a combination thereof. The ratio of the fluorosilane to the polysiloxane is, for example, between 1 and 0. To be more specific, the surface modifying precursor may use fluorosilane independently. The surface modifying precursor may use polysiloxane independently. In addition, the surface modifying precursor may be a mixture of fluorosilane and polysiloxane, and the ratio of fluorosilane to polysiloxane is 0.1:99.9-99.9:0.1, and preferably 80:20-99.9:0.1.

In an embodiment, the fluorosilane contains 1-17 fluorine atoms. The fluorosilane is, for example, F8261 (fabricated by Falcone Corporation), C₁₆H₁₉F₁₇O₃Si, CF₃C₂H₄—Si(OCH₃)₃. In another embodiment, the fluorosilane includes fluoralkylsilane, for example, fluoroalkyl group-containing trichlorosilane, fluoroalkyl group-containing trialkoxysilane, fluoroalkyl group-containing tricyloxysilane, fluoroalkyl group-containing triisocyanatesilane, or fluoroalkyl group-containing acrylatesilane.

Furthermore, the molecular weight of the polysiloxane is between 200 and 20000. In an embodiment, the polysiloxane is, for example, 1107 (fabricated by Dow Corning Corporation), and the chemical formula is as shown in (1),

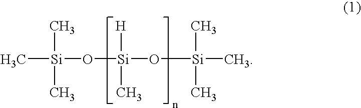

In another embodiment, the polysiloxane is, for example, polydimethylsiloxane or derivatives thereof, wherein the chemical formula of the derivative is as shown in (2),

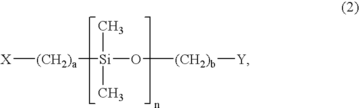

wherein a, b=0-10, preferably 0-5; X, Y respectively represent hydroxyl group, amino group, epoxy group, ether group, ester group, unsaturated carbon-carbon double bond group, halogen atom or a combination thereof, n=1-100.

Particularly, it should be noted that, if the surface modifying precursor uses the mixture of the fluorosilane and the polysiloxane, the fluorosilane and the polysiloxane may be premixed and then introduced into the equipment for the atmosphere pressure plasma process, or they may be introduced into the equipment for the atmosphere pressure plasma process respectively.

Next, the carrier gas is used to carry the gas of the surface modifying precursor into the atmosphere plasma equipment (Step 108). In an embodiment, the carrier gas includes air, nitrogen gas, argon gas, oxygen gas, helium gas or the mixture of the above two or more gases. In this manner, the gas of the surface modifying precursor may be dissociated into free radical molecules of the surface modifying precursor in the atmosphere plasma equipment. The free radical molecules of the surface modifying precursor are chemically bonded with the active free radicals on the surface of the substrate to form a film layer on the surface of the substrate. The thickness of the film layer is, for example, between 5 nm and 1000 nm.

The film layer formed above has hydrophobic, lipophobic, or hydrophobic and lipophobic characteristics depending upon the type and ratio of the used surface modifying precursor. For example, if the used surface modifying precursor is fluorosilane, the surface of the substrate processed by the atmosphere pressure plasma process has hydrophobic and lipophobic characteristics. If the used surface modifying precursor is polysiloxane, the surface of the substrate processed by the atmosphere pressure plasma process has hydrophobic characteristic. If the used surface modifying precursor is the mixture of fluorosilane and polysiloxane, the surface of the substrate processed by the atmosphere pressure plasma process has hydrophobic and lipophobic characteristics.

It should be noted that, if the used carrier gas adopts an oxygen-containing gas (for example, air, oxygen gas or a mixing gas of oxygen gas and nitrogen gas), the carrier gas is helpful for igniting and generating the plasma. In this manner, the process for forming the film layer on the surface of the substrate is accelerated. Furthermore, the present invention is not limited to performing the atmosphere pressure plasma process on a specific surface of the substrate, that is, the atmosphere pressure plasma process is performed on one, two, or two or more of the above surfaces of the substrate according to practical requirements.

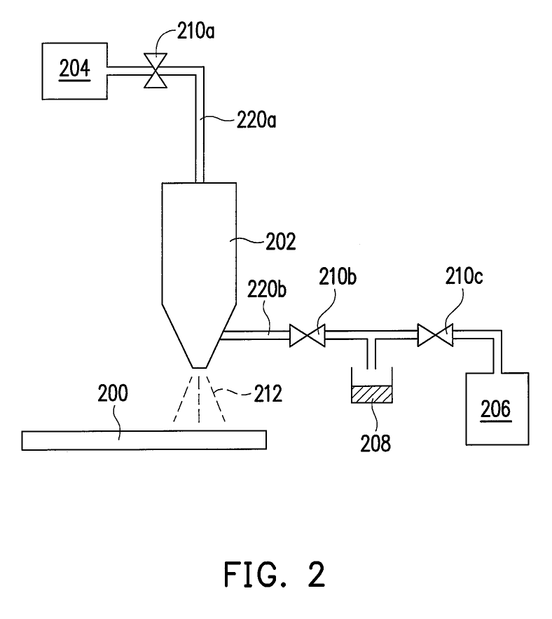

In an embodiment, the method of forming the film layer on the surface of the substrate is, for example, to use an atmospheric pressure plasma jet (APPJ) equipment as shown in FIG. 2. Referring to FIG. 2, the atmosphere plasma equipment includes a plasma nozzle 202, a plasma ignition gas supply unit 204, a carrier gas supply unit 206, a surface modifying precursor supply unit 208, pipe fittings 220a, 220b, and control valves 210a, 210b, 210c. The pipe fitting 220a is connected between the plasma ignition gas supply unit 204 and the plasma nozzle 202, and the control valve 210a is further disposed on the pipe fitting 220a to control the flow of the plasma ignition gas supplied by the plasma ignition gas supply unit 204. The pipe fitting 220b is connected between the carrier gas supply unit 206 and the plasma nozzle 202, and control valves 210b, 210c are further disposed on the pipe fitting 220b. The control valve 210c is used to control the flow of the carrier gas supplied by the carrier gas supply unit 206, and the control valves 210b is used to control the flow of the carrier gas and the flow of the surface modifying precursor volatilized from the surface modifying precursor supply unit 208. In addition, the substrate 200 is disposed below the plasma nozzle 202. The process gas 212 ejected from the plasma nozzle 202 is directly ejected to the surface of the substrate 200, and thereby forming a film layer on the surface of the substrate 200. Particularly, the plasma nozzle 202 scans the surface of the substrate 200 back and forth to completely deposit a film layer on the surface of the substrate 200. The method for the plasma nozzle 202 to scan the surface of the substrate 200 back and forth is, for example, moving the plasma nozzle 202 while keeping the substrate 200 still, or moving the substrate 200 while keeping the plasma nozzle 202 still. Additionally, the plasma nozzle 202 may scan the surface of the substrate 200 repeatedly, such that the whole surface is covered by the film layer.

Definitely, the present invention is not limited to using the APPJ equipment to perform the surface process on the substrate, and other atmosphere plasma equipments may also be used, for example, the dielectric barrier discharge equipment or the corona discharge equipment.

After the film layer has been formed on the surface of the substrate, referring to FIG. 1, a hydrophobic test (Step 110a) and a lipophobic test (Step 110b) are performed on the substrate. In this manner, it is determined that whether the surface characteristic is adjusted to hydrophobic, lipophobic, or hydrophobic and lipophobic after the substrate has been processed by the atmosphere pressure plasma process of the present invention.

Several examples are illustrated below to illustrate that the surface characteristic is adjusted to be hydrophobic, lipophobic, or hydrophobic and lipophobic, after the substrate is processed by the atmosphere pressure plasma process of the present invention.

### FIRST EXAMPLE

| | contact angle of | | | |
|---|---|---|---|---|
| | the water drop | | contact angle of | contact angle of |
| | and the | contact angle of | the oil drop and | the oil drop and |
| | substrate | the water drop | the substrate | the substrate |
| | (before | and the substrate | (before | (after |
| substrate | processing) | (after processing) | processing) | processing) |
| glass | 31 | 102 | 45 | 61 |
| cotton | 0 | 152 | 0 | 117 |
| cloth | | | | |
| PET | 68 | 143 | 0 | 97 |
| cloth | | | | |
| PC | 72 | 94 | 40 | 68 |

Note:
the surface modifying precursor used in the first example is F8261.

### SECOND EXAMPLE

| | contact angle of | | | |
|---|---|---|---|---|
| | the water drop | | contact angle of | contact angle of |
| | and the | contact angle of | the oil drop and | the oil drop and |
| | substrate | the water drop | the substrate | the substrate |
| | (before | and the substrate | (before | (after |
| substrate | processing) | (after processing) | processing) | processing) |
| cotton | 0 | 147 | 0 | 0 |
| cloth | | | | |
| PET | 68 | 98 | 0 | 0 |
| cloth | | | | |
| PC | 72 | 108 | 40 | 40 |

Note:
the surface modifying precursor used in the second example is 1107.

### THIRD EXAMPLE

| | contact angle of | | | |
|---|---|---|---|---|
| | the water drop | | contact angle of | contact angle of |
| | and the | contact angle of | the oil drop and | the oil drop and |
| | substrate | the water drop | the substrate | the substrate |
| | (before | and the substrate | (before | (after |
| substrate | processing) | (after processing) | processing) | processing) |
| cotton | 0 | 145 | 0 | 95 |
| cloth | | | | |

Note:
the surface modifying precursor used in the third example is a mixture of F8261 and 1107.

### FOURTH EXAMPLE

In the fourth example, a mixture of poly(dimethylsiloxane) (PDMS for short), bis(3-aminopropyl) terminated and 1H,1H,2H,2H-perpfuorodecyltriethoxysilane (FAS for short) is used as the surface modifying precursor. The weight ratio of PDMS:FAS is 95:5. After this surface modifying precursor is used to perform the surface modifying on the substrate through the APPJ equipment, the water contact angle obtained after being tested by the ASTM C 813-90 method is 101 degrees, and the oil contact angle is 53 degrees. The transparency obtained after being tested by the transparency test of ASTM D 1747-97 is 93%. The water contact angle obtained after being tested by the adhesion test of ASTM D 3359-95 is 100 degrees. The water contact angle obtained after being tested by the abrasion test under a pressure of 500 g/cm² is 91 degrees.

### FIFTH EXAMPLE

In the fifth example, PDMS and FAS are used as the surface modifying precursor, with the weight ratio of PDMS:FAS as 97:3. After this surface modifying precursor is used to perform the surface modifying on the substrate through the APPJ equipment, the water contact angle obtained after being tested by ASTM C 813-90 is 75 degrees, and the oil contact angle is 31 degrees. The transparency obtained after being tested by the transparency test of ASTM D 1747-97 is 93%. The water contact angle after being tested by the adhesion test of ASTM D 3359-95 is 72 degrees. The water contact angle obtained after being tested by the abrasion test under a pressure of 500 g/cm² is 71 degrees.

### SIXTH EXAMPLE

In the sixth example, PDMS is used as the surface modifying precursor, that is, the weight ratio of PDMS:FAS is 100:0. After this surface modifying precursor is used to perform the surface modifying on the substrate through the APPJ equipment, the water contact angle obtained after being tested by the ASTM C 813-90 method is 69 degrees, and the oil contact angle is 27 degrees. The transparency obtained after being tested by the transparency test of ASTM D 1747-97 is 93%. The water contact angle obtained after being tested by the adhesion test of ASTM D 3359-95 is 68 degrees. The water contact angle obtained after being tested by the abrasion test under a pressure of 500 g/cm² is 63 degrees.

To sum up, the atmosphere pressure plasma process is adopted in the present invention to adjust the surface characteristic of the substrate, which does not require a large quantity of solvent, and the processing time is relatively short. The method of the present invention is suitable for continuous production.

In addition, the surface modifying precursor used in the present invention provides the surface of the substrate with hydrophobic, lipophobic, or hydrophobic and lipophobic characteristics.

Furthermore, the atmosphere plasma equipment used by the present invention may perform the surface modifying on the substrates with different shapes and made of different materials, so it can be widely applied. That is to say, besides the surface modifying process performed on flat substrates (for example, the glass plate, the plastic cloth, and the textile product), the atmosphere plasma equipment also can be used in the surface process performed on complex fine molds, and screw parts.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of adjusting a surface characteristic of a substrate, comprising:
providing a substrate; and
performing an atmosphere pressure plasma process on the surface of the substrate to form a film layer on the surface of the substrate, so as to adjust the surface energy of the substrate, wherein a process gas of the atmosphere pressure plasma process comprises a surface modifying precursor, a carrier gas and a plasma ignition gas,
wherein the surface modifying precursor is selected from fluorosilane, polysiloxane and a combination thereof, and the ratio of fluorosilane to polysiloxane is between 0 and 1.

2. The method of adjusting a surface characteristic of a substrate as claimed in claim 1, wherein the fluorosilane contains 1 to 17 fluorine atoms.

3. The method of adjusting a surface characteristic of a substrate as claimed in claim 1, wherein the fluorosilane comprises fluoralkylsilane.

4. The method of adjusting a surface characteristic of a substrate as claimed in claim 3, wherein the fluoralkylsilane comprises fluoroalkyl group-containing trichlorosilane, fluoroalkyl group-containing trialkoxysilane, fluoroalkyl group-containing tricyloxysilane, fluoroalkyl group-containing triisocyanatesilane or fluoroalkyl group-containing acrylatesilane.

5. The method of adjusting a surface characteristic of a substrate as claimed in claim 1, wherein the molecular weight of the polysiloxane is between 200 and 20000.

6. The method of adjusting a surface characteristic of a substrate as claimed in claim 1, wherein the polysiloxane comprises a polymer as shown in the following chemical formula:

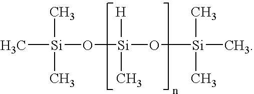

7. The method of adjusting a surface characteristic of a substrate as claimed in claim 1, wherein the polysiloxane comprises a polydimethylsiloxane or derivatives thereof, and the chemical formula of the derivative is shown as follows: 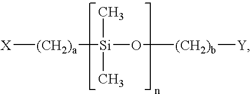
wherein a, b=0-10, X and Y respectively represent hydroxyl group, amino group, epoxy group, ether group, ester group, unsaturated carbon-carbon double bond group, halogen atom or a combination thereof, n=1-100.

8. The method of adjusting a surface characteristic of a substrate as claimed in claim 1, wherein the ratio of the fluorosilane to the polysiloxane is between 0.1:99.9 and 99.9:0.1.

9. The method of adjusting a surface characteristic of a substrate as claimed in claim 1, wherein the carrier gas comprises air, nitrogen gas, argon gas, oxygen gas, helium gas or a mixture of the above two or more gases.

10. The method of adjusting a surface characteristic of a substrate as claimed in claim 1, wherein the plasma ignition gas comprises air, nitrogen gas, argon gas, oxygen gas, helium gas or a mixture of the above two or more gases.

11. The method of adjusting a surface characteristic of a substrate as claimed in claim 1, wherein the thickness of the film layer is between 5 and 1000 nm.

12. The method of adjusting a surface characteristic of a substrate as claimed in claim 1, wherein the material of the substrate comprises an organic material or an inorganic material.

13. The method of adjusting a surface characteristic of a substrate as claimed in claim 12, wherein the inorganic material comprises glass, metal or ceramic.

14. The method of adjusting a surface characteristic of a substrate as claimed in claim 12, wherein the organic material comprises cotton, polyethylene terephthalate (PET) or polycarbonate (PC).

15. The method of adjusting a surface characteristic of a substrate as claimed in claim 1, wherein the surface modifying precursor comprises fluorosilane and polysiloxane, which are premixed and then introduced into an equipment for the atmosphere pressure plasma process, or which are respectively introduced into the equipment for the atmosphere pressure plasma process.

16. The method of adjusting a surface characteristic of a substrate as claimed in claim 1, wherein the surface modifying precursor is heated and then introduced into the equipment for the atmosphere pressure plasma process, or directly led into the equipment for the atmosphere pressure plasma process without being heated.

17. The method of adjusting a surface characteristic of a substrate as claimed in claim 16, wherein the surface modifying precursor is heated and evaporated at a temperature of 150-200° C., and then mixed with the carrier gas, and then introduced into the equipment for the atmosphere pressure plasma process.

18. The method of adjusting a surface characteristic of a substrate as claimed in claim 1, further comprising performing a cleaning and activating process on the surface of the substrate, before performing the atmosphere pressure plasma process to form the film layer on the surface of the substrate.

19. The method of adjusting a surface characteristic of a substrate as claimed in claim 1, wherein the atmosphere pressure plasma process performs a plurality of repeated processes on the surface of the substrate.
